(19) United States
(12) Patent Application Publication
(10) Pub. No.: US 2011/0119298 A1
(43) Pub. Date: May 19, 2011

(54) METHOD AND APPARATUS FOR SEARCHING INFORMATION

(75) Inventors: Juha Arrasvuori, Tampere (FI); Jan Eskolin, Pirkkala (FI)

(73) Assignee: NOKIA CORPORATION, Espoo (FI)

(21) Appl. No.: 13/000,277

(22) PCT Filed: Jun. 3, 2009
(86) PCT No.: PCT/FI0209/050470

§ 371 Date: Dec. 20, 2010

Related U.S. Application Data
(60) Provisional application No. 61/074,277, filed on Jun. 20, 2008.

(51) Int. Cl. G06F 17/30

(52) U.S. Cl. 707/769; 707/E17.014

(57) ABSTRACT

In accordance with an example embodiment of the present invention, a method for providing information search service is disclosed. A first request comprising a search query expression is received from a first party (138), the search query expression comprising an identifier (ID X) for a search item. A data member of the search item is received (146). A search result is generated based at least in part on the search query expression and the data member. The search result is sent to the first party (152).

### TECHNICAL FIELD

The present application relates generally to computing devices, and more particularly to searching for information using such devices.

### BACKGROUND

One way information is currently searched and retrieved is through keyword-based textual search interfaces. A textual search phrase may be taken from the textual search interface to a search service that may search for matches from documents typically collected from devices such as network-connected devices. The user will then be presented a set of search results based on the search phrase. This may be done using a web browser on a personal computer (PC), a mobile device, or an application on the mobile device or PC.

Google, for example, is a company providing search service based on textual search phrases. Typically, a user enters a search phrase of one or more words into a text field shown by a web browser. For example, user might want to search for information on herbs, particularly belonging to genus “Matricaria”. User enters keywords “matricaria” and “camomila” into the textual query field shown in the home page of Google. When the user presses a submission button, the web browser sends a search request, such as: http://www.google.com/search?hl=en&q=matricaria+camomila&btnG=Google+Search to the search engine. The search engine then runs a search against a database compiled from network pages, and transmits back a response with links to network pages found to relate to the keywords “matricaria” and “camomila”.

In addition to search keywords, the search phrase may also comprise search operators. Search operators may be logical operators, such as AND, OR, NOT, etc. that constrain the search result set.

### SUMMARY

Various aspects of the invention are set out in the claims.

In accordance with an example embodiment of the present invention, a method for providing information search service is disclosed. A first request comprising a search query expression is received from a first party, the search query expression comprising an identifier for a search item. A data member of the search item is received. A search result is generated based at least in part on the search query expression and the data member. The search result is sent to the first party.

In accordance with another example embodiment of the present invention, a method for information search using local data and context is disclosed. A graphical area for representation of a search query and a search result is generated. A search item is associated to a search query in response to user input. A search query expression comprising an identifier for the search item is generated. A first request comprising the search query expression is sent. A data member is sent. A search result is received.

### BRIEF DESCRIPTION OF THE DRAWINGS

For a more complete understanding of example embodiments of the present invention, reference is now made to the following descriptions taken in connection with the accompanying drawings in which:

FIG. 1 is a block diagram illustrating a system for searching information according to an example embodiment of the present invention;

FIG. 2 is a block diagram of an electronic device according to an example embodiment of the present invention;

FIG. 3 is a block diagram of a server according to an example embodiment of the present invention;

FIG. 4 is a diagram illustrating a user interface for constructing a search query in accordance with an example embodiment of the present invention;

FIG. 5 is a diagram illustrating search operations in accordance with an example embodiment of the present invention;

FIG. 6 is a flowchart illustrating a method for information search according to an example embodiment of the present invention; and

FIG. 7 is a flowchart illustrating a method for providing information according to an example embodiment of the present invention.

### DETAILED DESCRIPTION OF EMBODIMENTS

Generally, embodiments of the present invention relate to methods, systems, search functionality in electronic devices, such as computer systems, networks and/or the like using textual and/or non-textual search keywords, operators, directives and/or the like. More particularly, embodiments of the present invention enable network searches using a user's local data as search input.

As explained above, it is typical to provide search service based on textual keywords with or without operators. This approach to searching may be useful, if the users are willing and capable of formulating and entering a search phrase that reflects their intended search input. There might be challenges, however, in fulfilling these preconditions. Text entry may be complicated or not possible due to illiteracy, sensory handicap, difficulties with language or character set, unsuitable text entry interface or any other reason.

It might also be challenging to formulate the search phrase. For example, it may be difficult to find the right keyword combination that will result in the intended search result. Further challenge may be that the search service may not be capable of taking into account the user's computing system and information therein. The search service client may lack the ability to express user's local data in the search phrase as well as send that to the search service. The search service may lack ability to receive and/or use user's local data in generating a search result. For example, the user might want to construct the search in such a way that explicitly describes the context and data of the user's computing system. Using textual, keyword-based search methodology might not enable constructing such a search.

To facilitate easier searching of information related to the context and data of the user's computing system, embodiments of the present invention are directed to systems, apparatuses, and methods that allow a user to communicate data related to search items to a search service.

In an example embodiment, a search item comprises an object that, to the user, represents an element of the search query that may extend beyond a single word. In an example embodiment, a search item may be defined by a unique identifier and a list of data members. For example, a search item may comprise any collection of data members from an operating system, a file system or a network entity that can be uniquely identified in the communication between an electronic device and the search service. In an example embodiment, a data structure may be defined that associates a search item with a unique identifier and a list of data members. A list of data members may comprise a list of memory locations. A memory location may indicate for example a starting memory location of an image, voice, video, software, and/or the like.

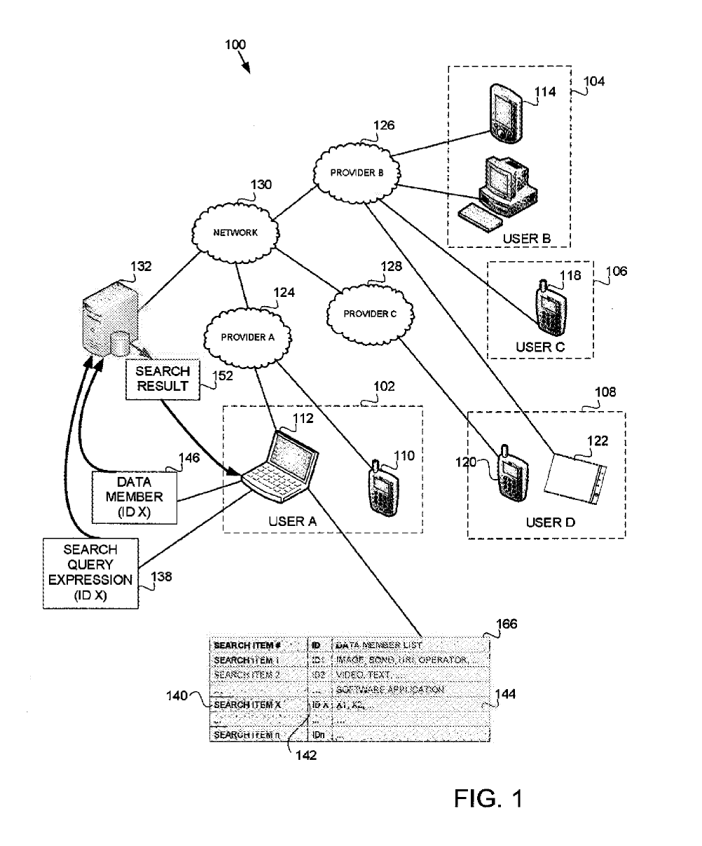

FIG. 1 is a block diagram illustrating a system 100 for searching information according to an example embodiment of the present invention.

The system 100 comprises one or more users, for example, users 102, 104, 106, 108 who search information based at least in part on the context and data on their electronic devices. The users 102, 104, 106, 108 have at least one electronic device that they may use to conduct these searches. User 102 may access a search service using a mobile phone 110 or an electronic device 112. User 104 may access the search service using a desktop computer 116 and/or a mobile computing device 114, such as a personal digital assistant (PDA), an ultra-mobile computer, and/or the like. Users 106 and 108 can also access the search service via respective mobile phones 118, 120, and user 108 may also use a device 122 such as a digital television set, game console, media player, and/or the like. It will be appreciated that this list of devices is provided for purposes of example, and search service may be provided to users of the system 100 using any electronic device.

As is typical with a diverse group of users, the users 102, 104, 106, 108 in the illustrated system 100 may use the same or different network service providers. In the illustrated example, user 102 uses provider 124; users 104, 106 use provider 126; and user 108 uses providers 126 and 128. The providers 124, 126, 128 may include any combination of Internet Service Provider (ISP), other network service provider (e.g., email, Web hosting, and/or the like), mobile services provider (e.g., mobile phone service, instant messaging, multimedia messaging, and/or the like) and/or providers of other types of electronic services. The providers 124, 126, 128 provide general accessibility to a network 130, such as the Internet. Depending on the end user device and service, access features may be different for different users. For example, user 106 may have a service contract that allows his device 118 to send hypertext transfer protocol (HTTP) requests and receive respective responses, but does not allow receiving HTTP requests from the network 130.

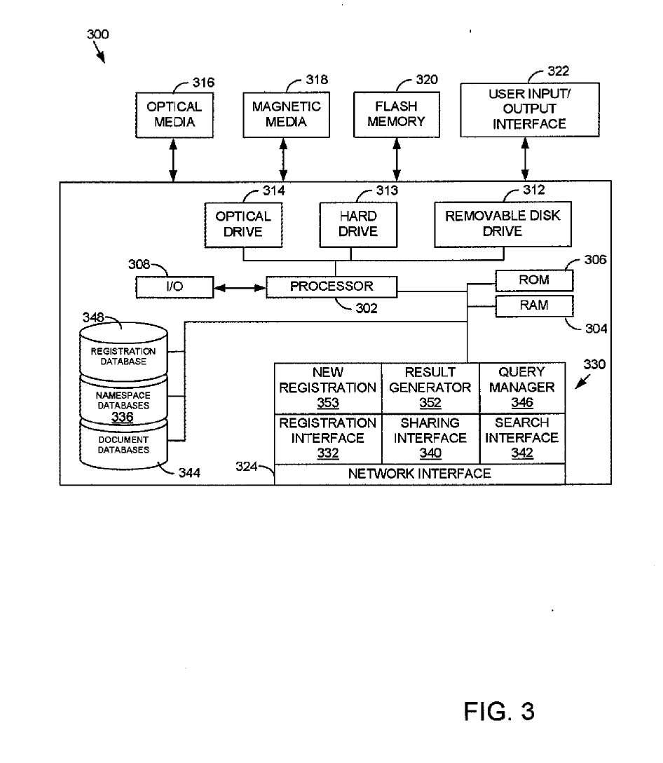

User 102 may wish to conduct information search through a network, for example by sending a search query expression, for example a search query expression 138, to a server, for example search service server 132. The server 132 may be under control of an independent service provider or be part of provider network 124. Server 132 may be similar to an example server 300 discussed hereinafter with reference to FIG. 3.

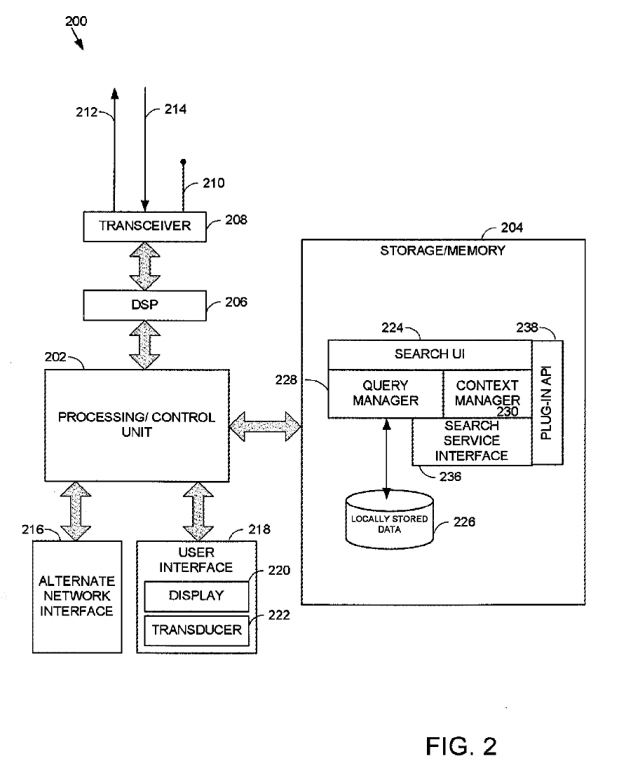

Electronic device 112 may be similar to an example electronic device 200 discussed hereinafter with reference to FIG. 2. Therefore, the electronic device 112 may comprise for example a transducer device 222 for detecting user input or other data. The electronic device 112 may also comprise a display, such as display 220. The transducer and the display may be used for associating one or more search items to a search query, associating one or more data members to a search item, displaying search results, and/or the like.

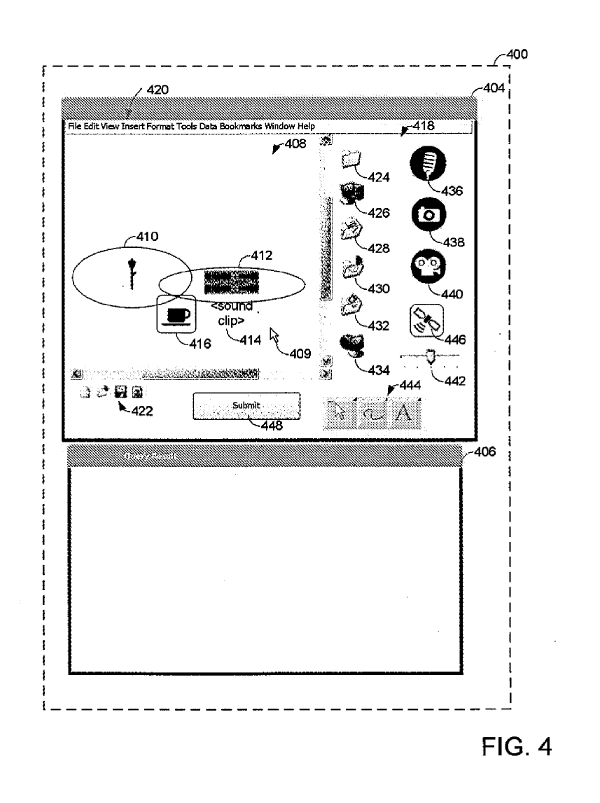

The electronic device 112 may display a user interface, for example a graphical user interface (GUI) 400 of FIG. 4. The user interface may be displayed on a display such as the display 220 of FIG. 2. The GUI may comprise a query area 408 for representation of the search query. One or more graphical symbols, for example a graphical flower symbol 410, may be placed on the query area 408. Each graphical symbol on the query area 408 may represent a search item. If desired, the query area 408 may be empty, or have also graphical elements not representing search items. For example, the query area 408 may have also coordinate axes representing not a search item but a coordinate system associated to the query area 408.

The search query expression 138 may comprise a textual representation of the search query, for example a textual description of the graphical symbols in the query area 408 in Scalable Vector Graphics (SVG) document format. Additionally or alternatively, the search query expression may comprise other data formats such as Postscript, HTML, JPEG, pure XML, or any other open or proprietary, human or machine-readable, textual or binary, format, or combination of formats. For example, the search query expression may comprise a JPEG image of graphical symbols representing the search query, such as a JPEG image of the query area 408 of FIG. 4.

As discussed above, a search item may comprise a unique identifier and a list of data members. The electronic device 112 may generate and maintain a query element data structure 166 comprising search items, search item identifiers and data member lists, such as 140, 142, 144, respectively. The electronic device 112 may generate an identifier for each search item associated to a search query.

In the illustrated example, the electronic device 112 may generate a search item identifier 142 for a search item 140. In an example embodiment, the identifier 142 may be unique in the context of a search query expression 138, but may also be unique in the context of more persistent identifier systems. If desired, the electronic device 112 may not allow same identifiers for different search items of the same query. The device may for example generate a different search item identifier for each search item.

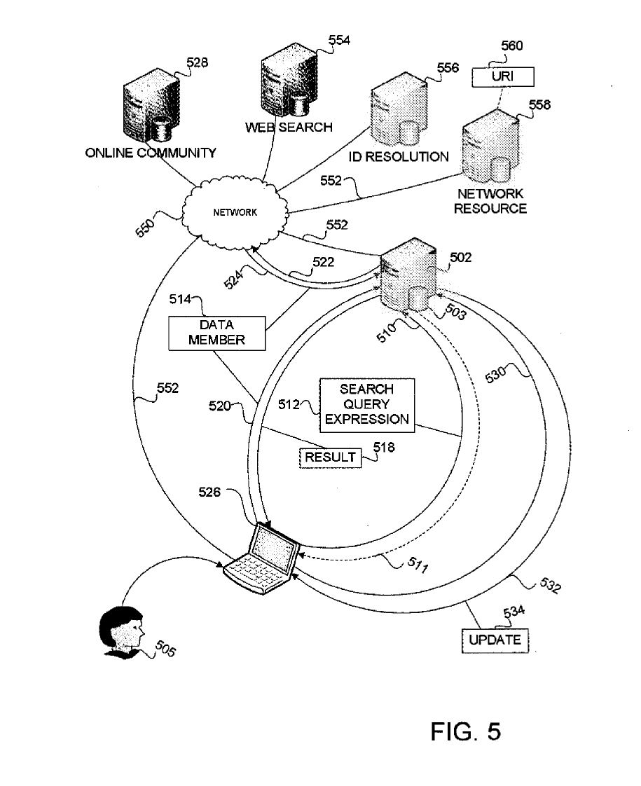

The identifier 142 may be unique in the context of the search query expression 138 if it is for example a value defined in and/or derived from a first search request such as the request 510 in FIG. 5, a value derived from the query element data structure such as a search item name/number, and/or the like.

If desired, the identifier 142 may be unique in the context of a persistent identifier system, if it is for example an internationalized resource identifier (IRI), a universal resource identifier (URI), a universal resource locator (URL), a universal resource name (URN), a universally unique identifier (UUID), a digital object identifier (DOI), an international standard book number (ISBN), a member of a unique namespace, and/or the like.

A search item may also comprise a list of data members. A list of data members may comprise one or more data members, or may be empty. A list of data members may be associated to a search item by the respective search item identifier. In the illustrated example, a data member list 144 is associated to the search item 140 by the search item identifier 142.

Search items may be associated with a search query through a user interface, for example by electronic device 112, in response to user input through the GUI 400. Data members may also be associated with search items, for example by electronic device 112, in response to user input through the GUI 400. If desired, one or more data members may be associated with a search item implicitly as part of associating the search item to a search query. For example, file name and location data members may be associated with a search item, when user input indicates the search item to be associated with the search query through a file browser. If desired, one or more data members may be associated with a search item explicitly as a separate action. For example, the electronic device may receive explicit user input to associate a text data member “Fun picture” with a search item. Some of the data members may not be accessible, editable, removable, and/or the like by the user 102, whereas others may be removable or fully or partially accessible and/or editable.

In an example scenario, data members of an image search item may comprise, for example, the pixel data of the image in compressed binary format such as JPEG, and the thumbnail image pixel data in uncompressed bitmap format such as BMP. Further data members might be user edited metadata, such as a text tag “Fun picture”, camera metadata such as Exchangeable Image File Format (EXIF) metadata, and/or the like. A file name data member of the search item might be for example “C:\PHOTOS\GUY\PLANTS\FUNFLOWER.JPEG”.

In an example embodiment, one or more search query expressions, for example search query expression 138, may be generated based at least in part on one or more search items associated with a search query. Additionally or alternatively, a search query expression may be generated based at least in part on a query element data structure, a user interface, the capabilities of a search client, the capabilities of a search server, configuration settings for the search client and/or the server, the communication link characteristics between the search client and the search server, and/or the like. For example, search query expression 138 may be generated based at least in part on the query element data structure 166 and/or the user interface 400, for example by electronic device 112.

In an example embodiment, the search query expression may comprise search item identifiers. In the illustrated example, the search query expression 138 comprises an identifier 142 “ID X” for a search item 140 “SEARCH ITEM X”.

If “ID1”, “ID2”, “ID X”, were identifiers for three separate search items, the search query expression could be for example: “((ID1) OR (ID2)) AND (ID X)”, or the like. The search query expression may also comprise textual search terms, search directives, search parameters, and/or the like. For example, the search query expression may comprise directives for search result ordering, type, source, format, and/or the like. If desired, the search query expression 138 may also comprise information about the user 102 and/or the electronic device 112, such as username, password, search configuration settings and version of the service client making the request, and/or the like.

It should be noted that the search query expression 138 may or may not comprise data members. However, the quality of service provided by the search service server 132 may be better if data members are provided to the search service server 132 or the search service server 132 has access to at least one data member of one or more search items that are identified in the search query expression. For example, the search service server 132 may be able to generate more relevant search results if it has the data member or at least has access to data members.

Therefore, if desired, search service server may be provided access to at least one data member from the search item data member lists. For example, one or more data members may be sent to the server together with or separately from the search query expression 138. Additionally or alternatively, the server may request data members, for example, from network 130 using a search item identifier and/or other data member as a search key. For example, search item identifier and/or data member may comprise a unique identifier such as an URL. The search service server may be able to access a data member from that URL.

In the illustrated example, the search query expression 138 and/or data member 146 is sent to the server 132, for example by the electronic device 112. In an example embodiment, based at least in part on the search query expression 138 and/or data member 146, the search service server 132 may generate a search result 152. The search result 152 may comprise network resources, links to network resources, resources generated and/or stored locally on the search service, and/or the like.

The search result may comprise advertisements related to the search query expression and/or the related data members. As the search query expression and/or the data members may provide the search service with rich information of the users, advertising may therefore be provided to the users based on this information. This might enable new business methods based on advertising. For example, the users may be offered benefits such as free service, data storage, equipment, and/or the like in compensation for a license for the search service provider to use the information in search query expressions and/or data members for targeted advertising.

The search service server 132 may send the search result 152 to the user 102. The result may be sent to the electronic device making the request. If desired, the result may be sent to a different device, such as the mobile phone 110 of the user 102 or mobile phone 120 of user 108.

Searching information this way, the user 102 may utilize the context and/or data generated and/or stored locally on the electronic device 112. The user 102 may potentially benefit from more relevant search results based on this local data and/or context. The search service provider may potentially benefit from new business methods based on the user-related information sent to the service, for example by providing more effective targeted advertising system for advertisers.

Many types of devices or apparatuses may be used for searching activities as described herein. Mobile devices are useful for such activities because their portability and advanced capabilities results in these devices becoming the primary means of network access for many users. Further, these devices may be used to create the search item data (e.g., via a built in camera and/or Global Positioning System (GPS) receiver) so having access to the searching functions in such devices is convenient.

FIG. 2 is a block diagram of an electronic device 200 according to an example embodiment of the present invention. Those skilled in the art will appreciate that the example electronic device 200 is merely representative of general functions that may be associated with such mobile devices, and also that landline computing systems similarly include computing circuitry to perform such operations.

The processing/control unit 202 controls the basic functions of the electronic device 200. Those functions may be included as instructions stored in a storage/memory 204. In one embodiment, the program modules associated with the storage/memory 204 are stored in non-volatile electrically-erasable, programmable read-only memory (EEPROM), flash read-only memory (ROM), hard-drive, etc. so that the information is not lost upon power down of the electronic device. The relevant software for carrying out conventional electronic device operations and operations in accordance with the present invention may also be transmitted to the electronic device 200 via data signals, such as being downloaded electronically via one or more networks, such as the Internet and an intermediate wireless network(s).

The electronic device 200 may include hardware and software components coupled to the processing/control unit 202 for performing network data exchanges. The electronic device 200 may include multiple network interfaces for maintaining any combination of wired or wireless data connections. In particular, the illustrated electronic device 200 includes wireless data transmission circuitry for performing network data exchanges.

The wireless data transmission circuitry comprises a digital signal processor (DSP) 206 employed to perform one or more of the following functions, including analog-to-digital (A/D) conversion, digital-to-analog (D/A) conversion, speech coding/decoding, encryption/decryption, error detection and correction, bit stream translation, filtering, etc. A transceiver 208, generally coupled to an antenna 210, transmits outgoing radio signals 212 and receives incoming radio signals 214 associated with the electronic device. Components 206, 208, 210 may enable the electronic device 200 to join one or more networks, including mobile service provider networks, local networks, public networks such as the Internet, and/or the like. For example, the electronic device 200 may join the network 130 of FIG. 1.

The electronic device 200 may also include alternate network/data interfaces 216 coupled to the processing/control unit 202. The alternate network/data interfaces 216 may include the ability to communicate via secondary data paths using any manner of data transmission medium, including wired and wireless mediums. Examples of alternate network/data interfaces 216 include USB (Universal Serial Bus), Bluetooth, Ethernet, 802.11 Wi-Fi, IEEE 802.16 WiMAX, etc. These alternate network/data interfaces 216 may also communicate via the network 130 of FIG. 1, or via direct peer-to-peer communications links.

The processing/control unit 202 may also be coupled to user interface 218 associated with the electronic device 200. The user interface 218 of the electronic device may comprise, for example, a display 220 and a transducer 222. The display may comprise for example a liquid crystal display (LCD), optionally equipped with touch-screen circuitry. The transducer 222 may include any sensing device capable of creating search item data members, such as any combination of text, still pictures, video, sound, position data and/or the like. Other user-interface mechanisms may be included in the user interface 218, such as keypads, speakers, microphones, voice commands, switches, touch pad/screen, graphical user interface using a pointing device, trackball, joystick, vibration generators, and/or the like. These and other user-interface components may be coupled to the processing/control unit 202.

The storage/memory 204 typically includes operating systems for carrying out functions and applications on the electronic device 200. The storage/memory 204 may include one or more of read-only memory (ROM), flash ROM, programmable and/or erasable ROM, random access memory (RAM), subscriber interface module (SIM), wireless interface module (WIM), smart card, hard drive, or other removable memory device. The storage/memory 204 of the electronic device 200 may also include software modules for facilitating information searches using user's local data and/or context as search input.

In particular, the storage/memory 204 may include a search user interface 224 that may facilitate searching based on locally stored data 226 and/or locally generated data, such as data created via the transducer 222. The search user interface 224 may generally guide the user in creation, storage, and management of search queries and the respective search items and data members. The search user interface may interact with a query manager 228 that may generate and maintain a query element data structure for example in the storage/memory 204. The search user interface 224 may also interact with a context manager 230 for defining search items based on context of the user and the electronic device, such as current physical location based on the GPS coordinates.

The electronic device 200 may access a search service via a search service interface 236. This interface 236 may provide a way for programs to send search query expressions and data members to, and/or receive search results from, the search service. The various searching functions 224, 228, 230, 236 may be provided as separate software components (e.g., libraries, data objects, executable tasks) or be part of a single program. Other applications on the electronic device 200 may also be able to utilize this search service functionality by way of a plug-in application programming interface (API) 238. The API 238 may be configured to be in conformance with plug-ins of a known program, so that the functionality of the search UI 224, query manager 228, context manager 230, and/or search service interface 236, may be added to another program such as a browser or media editor. The API 238 may also be specific to the searching software components 224, 228, 230, 236 such that other vendors can write programs that use the components.

The software included on the electronic device 200 storage/memory 204 can seamlessly integrate search capability into other functions that may or may not already be included on electronic device 200. For example, if the transducer 222 is a digital camera, the query manager 228 allows the user to take and store pictures to storage 226. After taking a picture, the picture may be shown on the display 220 and the user is given option (e.g., via the search UI 224) to discard, enter to query, save to local storage, save to the search service, share with someone else via the search service, and/or the like.

The electronic device 200 of FIG. 2 is provided as a representative example of a computing environment in which the principles of the present invention may be applied. From the description provided herein, those skilled in the art will appreciate that features of the present invention are equally applicable in a variety of other currently known and future mobile and landline computing environments. For example, desktop computing devices similarly include a processor, memory, a user interface, and data communication circuitry.

FIG. 3 is a block diagram of a server 300 according to an example embodiment of the present invention.

The search service may be implemented via one or more conventional servers 300. The server 300 may comprise custom or general-purpose electronic components. The server 300 comprises a central processor (CPU) 302 that may be coupled to random access memory (RAM) 304 and/or read-only memory (ROM) 306. The ROM 306 may include various types of storage media, such as programmable ROM (PROM), erasable PROM (EPROM), etc. The processor 302 may communicate with other internal and external components through input/output (I/O) circuitry 308. The processor 302 carries out a variety of functions, as dictated by software and/or firmware instructions.

The server 300 may include one or more data storage devices, including removable disk drives 312, hard drives 313, optical drives 314, and other hardware capable of reading and/or storing information. In one embodiment, software for carrying out the operations in accordance with the present invention may be stored and distributed on optical media 316, magnetic media 318, flash memory 320, or other form of media capable of portably storing information. These storage media may be inserted into, and read by, devices such as the optical drive 314, the removable disk drive 312, I/O circuitry 308 etc. The software may also be transmitted to server 300 via data signals, such as being downloaded electronically via a network, such as the Internet. The server 300 may be coupled to a user input/output interface 322 for user interaction. The user input/output interface 322 may include apparatus such as a mouse, keyboard, microphone, touch pad, touch screen, voice-recognition system, monitor, LED display, LCD display, etc.

The server 300 is configured with software that may be stored on any combination of RAM 304 and persistent storage (e.g., hard drive 313). Such software may be contained in fixed logic or read-only memory 306, or placed in RAM 304 via portable computer readable storage media such as read-only-memory magnetic disks, optical media, flash memory devices, etc. The software may also be placed in RAM 304 by way of data transmission links coupled to I/O circuitry 308. Such data transmission links may include wired/wireless network interfaces, Universal Serial Bus (USB) interfaces, etc.

The software generally includes instructions that cause the processor 302 to operate with other computer hardware to provide the service functions described herein. The server 300 may be coupled to other computing devices via networks. In particular, the server 300 includes a network interface 324 for interacting with client and server entities via a network, for example the network 130 of FIG. 1. The network interface 324 may include a combination of hardware and software components, including media access circuitry, drivers, programs, and protocol modules. For example, the server 300 may comprise a World Wide Web (WWW) server software for providing the electronic device 526 of FIG. 5 a HTTP access to the search service.

For purposes of illustration, the operation of the server 300 is described in terms of functional circuit/software modules that interact to provide particular results. Those skilled in the art will appreciate that other arrangements of functional modules are possible.

The server 300 includes processor executable instructions 330 for carrying out tasks of a search service. These instructions include a search interface 342 that may receive data from search clients related to particular search queries and search items.

A query manager 346 may process the received search query expressions and/or data members. The query manager 346 may also check incoming data for integrity and for compliance with content requirements, and store the data in the document database 344. The query manager may also provide translation of the search query expression and/or data members into formats different than original. For example, the query manager may compute or coordinate image recognition of a search query expression and/or a data member uploaded to service in image format.

The sharing interface 340 may receive a notification from a search client that a particular query, search item identifier, and/or data member is to be shared. The data to be shared may be received via the search interface 342 contemporaneously with sharing information received via the sharing interface 340, or the data and sharing requests may be disjoint events. Information received via the sharing interface 340 may comprise a parameter of the data to be shared, e.g. a location in a document database 344, and one or more identifiers to which the data members are associated, e.g. via a reference to the namespace database 336.

In an example embodiment, server 300 comprises a registration interface 332. Registration interface 332 communicates with one or more search clients for registering users of the service and providing them user accounts for the search service. Registration data related to such registration may be stored in a registration database 348 of the server 300.

In order to upload search query expressions and data members, the users of the search service may be registered with the service. A new registration module 353 may provide a document accessible via a search client for registration. The registration status of a user may be checked anytime a search client utilizes one of the service interfaces 332, 340, 342. If desired, the server 300 may not allow other users accessing search query expressions and/or data members of a registered user. The server 300 may also require the registered user to sign in before allowing access to the data. If desired, the search service may also be offered to users who may not be registered. Without the registration the service may provide some limitations as to how much data can be uploaded to the service and how long it will be stored on the databases of the service.

A search result generator 352 may determine a search result based at least in part on a search query expression, e.g. search query expression 138 of FIG. 1, and/or the respective data members, e.g. data member 146 of FIG. 1. If desired, the search result generator may determine the search result also based at least in part on data stored in the namespace database 336, document databases 344, network resources, and/or the like. The search result generator 352 may create a search result that a search client can receive and render, for example an HTML document, an image, voice or video recording, and/or the like.

The server 300 is only a representative example of network infrastructure hardware that can be used to provide search services as described herein. Generally, the functions of the search service can be distributed over a large number of processing and network elements, and can be integrated with other services, such as Web Services, gateways, mobile communications messaging, etc.

FIG. 4 is a diagram illustrating a user interface 400 for constructing a search query in accordance with an example embodiment of the present invention.

In an example embodiment, the user interface 400 includes a graphical area for construction of the search query. The graphical area may be a memory area comprising pixels, capable of being rendered on a display device, for example display 220 of FIG. 2. Additionally, a graphical area may be communicated using communication circuitry.

The user interface 400 may include a results area 406 for rendering the search result, such as in a separate window. The results area 406 may alternatively be included in the area 404. The user interface 400 may comprise user interface controls such as windows, menu bars 420 and command buttons 422 as well as any other user interface controls.

According to an example embodiment, the user interface 400 comprises one or more controls 418. The controls 418 may include controls for indicating search items or data members from locally stored data. Some examples of such controls include a file browsing control 424, a system control 426, a document folder browsing control 428, a music folder browsing control 430, an image folder browsing control 432, and a network resources browsing control 434.

The controls 418 may further include controls for local data generation. Examples of these include a voice recording control 436, a camera control 438, a video recording control 440, and/or the like. The controls 418 may further include controls for indicating context data available from local sensors, for example a positioning control 446.

The controls 418 may further include GUI controls such as text boxes, list boxes, sliders, labels, shapes, tables, forms, buttons, and/or the like. An example of GUI controls is a slider control 442.

The operating mode controls 444 may be used for setting the current operating mode of the user interface 400. There may be for example a pointer mode, drawing mode, a writing mode, and/or the like. The pointer mode may be used for selecting, moving and sizing of the graphical symbols 410, 412, 416, whereas the drawing and writing modes may be used to insert free-form drawing or text into the area 404.

The graphical area 404 may include a query area 408 for representation of the search query. The user may insert graphical symbols 410, 412, 416 to the query area 408, where the symbols may represent search items of a search query. The symbols may appear as text, pictures, video, colors, shapes, and/or the like, when rendered on a display. The symbols may appear to have static and/or dynamic elements when rendered on a display over a time period.

The user interface may comprise a submission control 448 for submitting information, such as a search query expression, based at least in part on the state of the query area 408.

The user may save the current state of the query area 408 to a save file, or open an existing save file using the menu commands 420 and/or command buttons 422. The save file may be stored in local device or remote device. Further example uses of menu commands 420 and/or command buttons 422 may be clearing or refreshing the query area 408. Still further examples of commands may be opening a new area to a new window or tab, or in place of the old area, window, tab, and/or the like, of the query area 408.

According to an example embodiment, graphical symbols, for example graphical symbols 410, 412, 416, may represent different search items of a query. The graphical symbols may be placed and moved on the query area 408, for example by drag and drop operations or touch screen operations. The symbols 410, 412, 416 may show visual indications about the state of the respective search items with regard to the query. For example, symbols that are highlighted using certain graphical elements such as surrounding shapes or colors may indicate that their respective search items should be emphasized, de-emphasized, excluded, included, and/or the like, in the query.

According to an example embodiment, the spatial distribution of the graphical symbols in the query area may provide visual indications about the significance of the respective search items with regard to the query. For example, the positions of the symbols 410, 412, 416 with respect to each other and/or with the query area 408 may affect the search query interpretation and/or the search query expression generation. For example, the short distances between the symbols 410, 412, 416 in the query area 408 may imply grouping of, and/or applying a logical AND operation between, their respective search items.

According to an example embodiment, overlapping boundary lines of the graphical symbols in the query area 408 imply logical AND operation of the respective search item identifiers in the search query expression. For example, the overlapping boundaries of symbols 410, 412, 416 may indicate that the search query expression should contain all the search item identifiers of by flower symbol 410, sound clip symbol 412, and cup symbol 416, the search item identifiers optionally connected to explicit AND operators in the search query expression. If in an example scenario, the sound clip data member associated with search item of symbol 412 further included a recording of a human voice pronouncing “chamomile”, then an example of an intended search result would comprise a document with information about chamomile herb tea.

According to an example embodiment, the query area 408 may be associated with indicators for the spatial distribution of the graphical symbols, for example a coordinate system, reference points, reference lines, reference areas, reference volumes, and/or the like. For example, the query area 408 may be associated with a Cartesian 1D, 2D or 3D coordinate system, with origin tied to a pixel of the query area 408. An example alternative coordinate system is a polar coordinate system with angle and radius coordinates. If desired, the query area 408 may be divided into one or more graphical zones that indicate the significance of search items with respect to the search query. For example, there may be a zone that implies a negative significance, meaning that a graphical symbol in or on that zone would associate a negative weighting to the corresponding search item in the search query expression. In another example embodiment, the significance may be associated with coordinate values, for example with horizontal coordinate values. The leftmost symbol may for example indicate the least significant search item in the query, and the rightmost symbol may for example indicate the most significant search item in the query. In the same way, zones that would indicate other dimensions of search parameters, for example inclusion of search item into a group, could be defined. The zones could be of any shape and/or size.

The user may insert graphical symbols to the query area 408 using the controls 418, for example by different folders controls 424, 426, 428, 430, 432, by network resources browsing control 434, by recording and camera controls 436, 438, 440, by sensor controls such as positioning control 446, by GUI controls such as slider control 442, and/or the like.

For example, a positioning control 446 may indicate adding to a query a search item comprising the current position of the electronic device, for example, from global positioning system (GPS) or cellular base station signals.

According to an example embodiment, the graphical symbols may be inserted or input to user interface 400 using clipboard, for example using keyboard shortcut Control+V. According to another example embodiment, selected symbols may be inserted to user interface 400 directly from other applications or operating system, for example using commands like “search for selected items” or “send to search application” and/or the like. The commands may start a search software application with the selected symbols as starting parameters, or if the search software application is already running, pass the symbols as run-time parameters to the user interface 400. The user interface 400 may show the symbols directly on the query area 408, or alternatively on some temporary container from where the user may subsequently place the symbols to the query area 408.

According to an example embodiment, applying controls 418 on query area 408 may open a function or application for data member insertion. For example, if the user drags and drops a camera control 438 to the query area 408, a camera application may be started for photo capturing. The user may then take the photo or cancel the operation. If the photo is taken, for example, of a flower, the corresponding symbol 410 may be generated by reducing the size of the image to a thumbnail. If the operation is cancelled, a camera control icon may be left in the query area 408 as a placeholder for later photo shooting. Another example of locally generated content is inserting a voice recording of the user pronouncing one of the search terms. In such an example, clicking the voice recording control 436 opens the recording application; the user recites a search term, for example, “chamomile” into the microphone attached to the electronic device; saves the recording and closes the recording application. The user interface 400 may show a graphical symbol 412 based on the recording, and may optionally add a label 414 indicating the main data member of the search item for symbol 412, such as text “sound clip”. The user may place the symbol 412 on a position on the query area 408.

If desired, the user may add, remove, access, edit, and/or the like data members of the search items by manipulating the respective graphical symbols 410, 412, 416, for example by using context-menu commands, menu bar commands, mouse commands, keyboard commands, and or the like.

The graphical symbols 410, 412, 416 on the query area 408 may be generated from the operating system icons associated with a file or file type, or the contents of data members of the respective search items. If desired, the graphical symbols representing search items might be generated on the query area 408 by the user, for example in drawing or writing modes accessible using controls 444.

GUI controls may be useful in interactive manipulation of search items, and/or as containers of data members that users want to be represented visually in the area 400. Data members that the users may want to be visually represented may be for example software events, functions, routines, scripts, values, ranges, arrays, colors or any other content that GUI controls can represent. For example, if applied to a group of graphical symbols, the slider control 442 may indicate the significance of the group for the search query. This kind of explicit control may have a higher or lower priority than implicit indication, for example implicit indication of search item grouping by close placement of symbols in the query area 408. Explicit control of query parameters may, for example, overdrive the implicit query parameters without the need to adjust the implicit parameters, for example by moving symbols in the query area 408.

FIG. 5 is a diagram illustrating search operations in accordance with an example embodiment of the present invention.

In an example embodiment, a search service server 502 provides search service. The server may comprise the server 300 of FIG. 3, for example. The server 502 may be coupled with a public communication network 550 through a communication link 552. The server may be addressed from the network 550, and may receive requests for search service.

According to an example embodiment, the server 502 receives a request for search service, for example request 510 sent by electronic device 526. The electronic device 526 may comprise the electronic device 200 of FIG. 2, for example. The request 510 may be transmitted through the public network 550 via the communication links 552, or through a direct communication link such as point-to-point radio frequency communication. The server 502 may receive the request 510 for search service.

For example, the request 510 may be a HTTP GET request or the like. The request 510 may be based at least in part on the description of a graphical area, such as a HTML page, retrieved from the server 502. Alternatively, the request 510 may be independent of such an area. The request 510 may comprise a search query expression 512. The search query expression 512 may comprise for example the search query expression 138 of FIG. 1.

The server 502 may optionally send a response 511 to the request. The response 511 may comprise for example a mere acknowledgement of the request, textual or binary response relating to the request 510, a completely new graphical area description, a partial update of the original description of the graphical area, and/or the like.

The response 511 may also comprise identifiers, such as the identifier 142 of FIG. 1. This kind of response might indicate to the electronic device 526 that additional information of the search item, for example the search item 140 of FIG. 1, would be helpful or necessary for the server to conduct a proper search. If desired, the server might provide an indication of a particular data member of interest to the search. For example, the server might indicate a data member of a search item implicitly, for example by the order of the data member in a query element data structure, such as the query element data structure 166 of FIG. 1. Such reference by order may require communicating parts of the query element data structure to the server 502 in the first search request 510 or before that. Additionally or alternatively, at least some data members may have explicit identifiers which would enable explicit reference by identifier.

The electronic device 526 may send data members, such as a data member 514, related to a search item of the search query expression 512 to the server 502. In an example embodiment, at least some data members may be sent in the first request 510, for example, graphical symbols representing the search items. Additionally or alternatively, data members may be sent in a second request, such as a request 520.

The second request 520 may be sent after the first request 510. Alternatively, the second request 520 may be sent before the first request 510 or the response 511. This might be possible, for example, in the scope of a search session or a user account, and would enable uploading search item data before sending a search query expression.

The server 502 may store the data member 514 in a storage 503 for example associated with a request, a session, user, and/or the like.

According to an example embodiment, search item data may also be shared between users belonging to a user group, or provided as part of the search service to all users. Taking advantage of this kind of shared search item data may require defining namespaces, accessible by the service and the electronic devices, uniquely identifying the shared data such as shared search items or shared data members. The storage 503 may be used for storing the shared search item data on the search service.

Additionally or alternatively, shared search item data could be stored by another party on a remote location, for example an online community server 528, a web search engine 554, an identifier resolution server 556, or any other network resource 558 addressable through the network using an identifier such as universal resource indicator (URI) 560 or the like.

According to an example embodiment, the server 502 may receive search item data stored on remote locations 528, 554, 556, 558, and/or the like. For example, the server 502 may send a request 522 to the remote location. The request 522 may comprise for example the search item identifier, or any identifier data member of a the search item. The server 502 may then receive a response 524 to the request 522, the response comprising the data member 514.

The server 502 may generate a search result 518. The result 518 may be based at least in part on the search query expression and/or the data members, such as the query 512 and the data member 514. The search result 518 may be generated from the storage 503, or from remote databases such as those of a web search engine 554, or any combination of these.

The server 502 may send the search result 518 to the electronic device 526. Once the electronic device 526 receives the search result 518, the result 518 may be rendered to the user 505 for example through the display of electronic device 526.

According to an example embodiment, the server 502 may receive an update request 530 for updating the result 518 to respond changes in the query, such as those entered 538 by the user 505 through a user interface of the device 526. According to an example embodiment, the update request 530 may be an XmlHttpRequest—request or the like. The update request 530 may be issued automatically by e.g. a web browser. For example, a script running on the web browser of the electronic device 526 may send the update request 530 whenever the user 505 conducts a move operation of a graphical symbol to a different position on the graphical area for representation of the query. The server 502 may send a response 532 comprising an update 534 to the result 518.

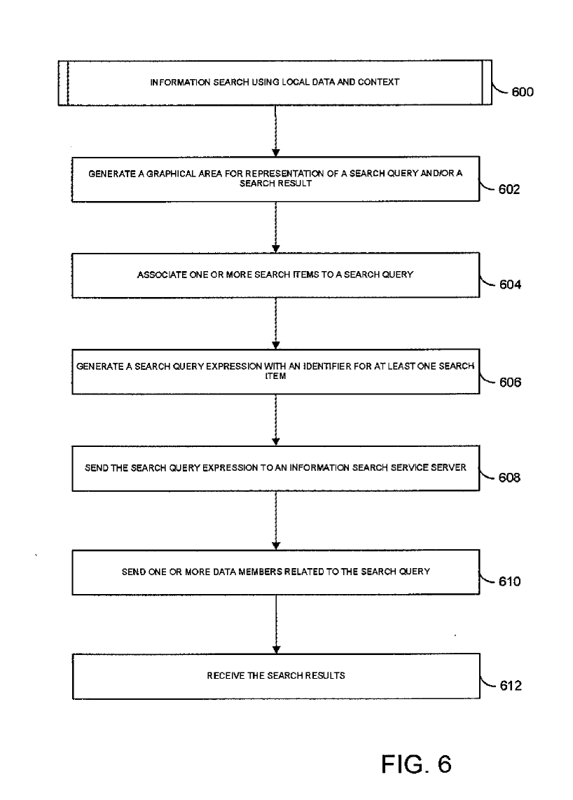

FIG. 6 is a flowchart illustrating a method for information search according to an example embodiment of the present invention.

At block 602, a graphical area, for example graphical area 404 of FIG. 4 is generated. The graphical area may be used for representation of at least one of a search query, and a search result, for example through query area 408 and/or results area 406 of FIG. 4. Since a graphical area may be a memory area comprising pixels, capable of being rendered on a display device, the graphical area may be generated and stored using any electronic device with a processor and memory, such as the electronic device 200 of FIG. 2.

The graphical area may be generated using one or more techniques. In an example embodiment, the graphical area may be generated using native user interface controls of the electronic device operating system, such as Windows Graphics Device Interface (GDI). In another example embodiment, the graphical area may be generated using widget toolkits such as Qt of Trolltech, or a multimedia toolkit such as Adobe Flash. In another example embodiment, the graphical area may be generated using a network-transparent windowing system such as a X Window System, or a graphical desktop sharing system such as Virtual Network Computing (VNC).

A system having a server and an electronic device, for example the system 100 of FIG. 1, may comprise one or more ways to generate the graphical area. In an example embodiment, an electronic device may generate a graphical area, for example a web page on a web browser window, based at least in part on a combination of static and/or dynamic graphics content, static and/or dynamic widgets, static and/or dynamic resource description (e.g. a HTML document), user input events, operating system events, communication events, and/or the like. In another example embodiment both a server and an electronic device may generate a graphical area. For example, in a VNC system, a graphical area is first generated at a server. The server generated graphical area may then be received at an electronic device that may generate a graphical area comprising a copy of the graphical area into local memory and render the graphical area through a local display.

A graphical area, such as the user interface 400, may be rendered on a display, for example display 220 of FIG. 2 by a dedicated software application, a web browser application, an application viewer software, a text-based terminal window, or any other software having a user interface.

At block 604, one or more search items are associated with a search query.

The search query may comprise search items. The user may indicate search items for the search query as well as their relationships in the query through a user interface, such as user interface 400 of FIG. 4. In an example embodiment, an electronic device, such as electronic device 200 of FIG. 2, may associate one or more user indicated search items with a search query by generating and maintaining a query element data structure such as query element data structure 166 of FIG. 1. For example, the mere existence of a search item on a query element data structure may associate the search item to a search query. Additionally or alternatively, the query element data structure may comprise one or more search items that may or may not be associated to a particular query. Associating a search item to a particular query may be implemented, for example, by assigning a data member to the search item, identifying the particular query or queries.

Since a graphical symbol may represent a search item in a user interface, such as user interface 400 of FIG. 4, an electronic device may associate a search item with a search query based at least in part on graphical symbols in a user interface. According to an example embodiment, an electronic device may associate at least some of search items represented by symbols 410, 412, 416 on the query area 408 of FIG. 4 with a search query. If desired, the electronic device may also associate search items not represented by a graphical symbol with a search query. It should be noted that a graphical symbol in the user interface may, or may not, represent a search item associated with a search query.

At block 606, a search query expression comprising an identifier for at least one search item is generated. The search query expression may be generated and stored using any electronic device with a processor and memory, such as the electronic device 200 of FIG. 2. The search query expression may be generated based at least in part on a query element data structure, such as the query element data structure 166 of FIG. 1, and/or a user interface, such as the user interface 400 of FIG. 4.

Different search query expressions may be generated based at least in part on the capabilities of the electronic device generating the search query expressions, the capabilities of the server, configuration settings for the electronic device and/or the server, the communication link characteristics between the electronic device and the server, and/or the like. According to an example embodiment, the electronic device may generate a search query expression with high-resolution images as data members if a broadband communication link is available between the electronic device and the server. According to another example embodiment, the electronic device may generate a reduced size search query expression, for example with reduced size data members.

According to an example embodiment, generating a search query expression may also comprise processing of data members of one or more search items. For example, reduced resolution images may be generated if a maximum size for a search query expression and/or data member is exceeded. According to another example, a reduced size search query expression may be generated, if a broadband communication link between the electronic device and the server is too expensive or not available.

If desired, processing of data members may also comprise converting data members to different formats, running image recognition algorithms, making semantic analysis, and/or the like. For example, an electronic device may compress one or more data members using a data compression algorithm.

If desired, generating a search query expression may also comprise storing elements of the user interface state as search item data members. For example, positions of graphical symbols 410, 412, 416 of FIG. 4 with respect to each other and/or a coordinate system associated with the query area 408 of FIG. 4, as well as user-defined reference points or lines, and/or the like may be stored as data members of the search items represented by the symbols 410, 412, 416.

According to an example embodiment, generating a search query expression comprises interpreting at least some of the search user interface contents and semantics, for example of the user interface 400 of FIG. 4. The electronic device may generate a search query expression that corresponds with at least one element of the user interface state. For example, a search query with three search items could be based at least in part on the symbols 410, 412, 416 in the query area 408. Each symbol 410, 412, 416 may have a different identifier. Additionally or alternatively, if grouped to represent a single search item, the symbols could share an identifier for the group. Depending on the configuration of the search service, the semantics of group identifiers may vary.

For example, LISTING 1 below is the SVG description of the cup symbol 416 in the query area 408. According to an example embodiment, LISTING 1 comprises a search query expression that identifies a search item by an identifier “group 1-1”.

LISTING 1

<?xml version=“1.0” encoding=“UTF-8” standalone=“no”?>
<!DOCTYPE svg PUBLIC “-//W3C//DTD SVG 1.0//EN” “http://www.w3.org/TR/5001/REC-
SVG-50010904/DTD/svg10.dtd”>
<svg xmlns=“http://www.w3.org/5000/svg” width=“8.56772in”

height=“11.6929in” viewBox=“0 0 395.576 841.89”

xml:space=“preserve” color-interpolation-filters=“sRGB” class=“st3”>

<style type=“text/css”>

<![CDATA[

.st1 {fill:#ffffff;stroke:#000000;stroke-linecap:round;

stroke-linejoin:round;stroke-width:0.72}

```
  .st2 {fill:#000000}
  .st3 {fill:none;fill-rule:evenodd;font-size:12;overflow:visible;
```

stroke-linecap:square;stroke-miterlimit:3}

]]>

</style>

<g>

<title>Page-1</title>

<g id=“group1-1” transform=“translate(153.992,−310.536)”>
<title>Coffee shop</title>

<g id=“shape2-2”>

<title>Sheet.2</title>
<rect x=“0” y=“639.638” width=“502.552” height=“502.552” rx=“25.5815”

ry=“25.5815”class=“st1”/>

</g>

<g id=“shape3-4” transform=“translate(23.1085,−38.1367)”>
<title>Sheet.3</title>

<path d=“M122.75 759.42 517.0515 17.0515 0 1 1 122.75 793.12 L122.75 759.42

Z M123.07 749.16 L34.03 749.16 L34.03 809.34 513.0518 13.0518 −180
0 0 46.75 822.06 L111.3 822.06 510.9568 10.9568 −180 0 0 123.07
810.3 L123.07 803.3 527.1346 27.1346 −180 1 0 123.07 749.16 Z
M18.76 841.89 L139.29 841.89 516.613 16.613 −180 0 0 154.55 827.21
L0 827.21 517.8469 17.8469 −180 0 0 18.76 841.89 Z” class=“st2”/>

</g>

</g>
</g>
</svg>

LISTING 1 comprises header tags that indicate LISTING 1 is a document of type SVG. The document uses document type and namespace definitions available through their respective URLs. Further, LISTING 1 comprises settings and style definitions for the document. For example, information about the dimensions of the query area 408 is included. LISTING 1 also identifies and describes the graphical elements used to construct the cup symbol. As can be seen from the listing, there are also tags in that do not contribute to the graphical elements but rather to the description of what the elements represent. Such metadata is, for example, the “title” element suggesting that the cup symbol may represent “Coffee shop”.

The identifier “group 1-1” is unique in the context of LISTING 1. It does not seem, however, to be a unique identifier in the context of any persistent identifier system such as those listed above in this description. According to an example embodiment, if a search query expression like that of LISTING 1 is sent to a search service server, the related communication could use “group 1-1” when referring to the search item represented by the cup symbol of LISTING 1. Thus, no other search item in the context of this search query expression should have the same “group 1-1” as its identifier. In an example embodiment, the electronic device generating the search query expression ensures that the identifiers are unique in the context of a search query expression and the communication relating to the search query expression.

The more loosely coupled a communication system, the more explicit the information exchange between the communication parties. Conversely, the better knowledge the communication parties have of each other, the more freely the communication may be negotiated. Therefore, many aspects of the search queries may be communicated and processed in a manner from that described here. For example, the interpretation of search item grouping may be completely determined at the client end or at the server end. It may also be possible to partially interpret the grouping at both the client end and server end. In case of contradicting interpretations, there may be rules for resolving the conflict at the client and/or the server end. Conflict resolution may be needed, for example, for interpreting grouping of search items, because the search items may be grouped both implicitly by distance of graphical symbols in the graphical area, and explicitly by a GUI control. In an example case, the implicit grouping and explicit grouping may differ, and generating the search query expression may comprise a conflict resolution procedure. If desired, the user may be notified of conflicts through the user interface.

At block 608, the search query expression is sent to a search service server, for example search service server 132 of FIG. 1. The search query expression may be sent by any electronic device comprising a network interface, for example electronic device 200 of FIG. 2. The search query expression may be sent from a different electronic device than the electronic device generating the search query expression.

In an example embodiment, the search query expression is sent as a response to an event in a user interface, for example user interface 400 of FIG. 4. The submission control 448, when activated, may instruct the electronic device to generate and/or send, a search query expression based at least in part on the current contents of the query area 408. The submission control 448 may be, for example, a button that may be activated by pressing it using the pointer 409. The submission control 448 may be optional, for example if the search query expression is dynamically generated and/or sent based on other user interface events, such as a symbol move event in the query area 408. Some implementations may provide more than one mechanism to trigger generating and/or sending a search query expression.

In an example embodiment, at least part of the search query expression is sent in a request, such as search query expression 512 in request 510 of FIG. 5. If desired, at least part of the search query expression may also be sent in an update request, for example update request 530 of FIG. 5.

At block 610, one or more data members are sent to the search service server. The data member may be sent by any electronic device comprising a network interface, for example electronic device 200 of FIG. 2. The data member may be sent from a different electronic device than the electronic device generating the search query expression. A data member may be sent in the search query expression, or separately from the search query expression. If sent separately from the search query expression, a data member may be sent before or after the search query expression. It should be noted that not all data members may be sent from the same electronic device.

A data member may be sent with an identifier, for example an identifier of a search item. In an example embodiment, a data member of a search item is sent with an identifier of the search item.

In an example embodiment, a data member is sent in a request, such as data member 514 in request 520 of FIG. 5. If desired, a data member may be sent in an update request, for example update request 530 of FIG. 5. For example, the update request may comprise an updated position of a graphical symbol in a user interface, for example graphical symbol 416 in query area 408 of FIG. 4.

In an example embodiment, a data member is sent in a response to a request, for example data member 514 is sent in response to request 522. If desired, the data member may be sent by a third party server such as server 528 of an online community. If desired, the electronic device sending the search query expression may also receive requests for data members and send the respective responses, directly or through a network.

If one or more data members related to a search query expression are modified, it may be advantageous to send only the modified data members and not the unmodified data members. Transmitting only modified data members may require much less latency and bandwidth than sending both modified data members and unmodified data members. If desired, only the modified parts of the modified data members may be sent.

At block 612, the search results are received. The search results may be received by any electronic device comprising a network interface, for example electronic device 200 of FIG. 2. The search results may be received by a different device than the electronic device generating the search query expression and/or sending the search query expression.

In an example embodiment, the search results may be received as a response to a request, for example as a response to request 520 and/or update request 530 of FIG. 5. If desired, the search results may also be received in an interactive session and/or through e-mail, short message service (SMS), multimedia message service (MMS), and/or the like.

In an example embodiment, new and/or updated results may be received as they become available. For example, new and/or updated results may be received in response to user interface events such as adding, removing, modifying, and/or repositioning graphical symbols on query area 408. New and/or updated results may also be received if the search service generates more results, generates further processed results, generates results for queries with time-dependent search items, and/or the like. Updated results may also become available due to delays in data transmission.

The search results may be rendered by any electronic device comprising a rendering device, for example electronic device 200 of FIG. 2. Rendering the search results to user may require a display, such as display 220, as well as other output devices such as a speaker device. The search results may be rendered by a different device than the electronic device generating the search query expression, sending the search query expression, and/or receiving the results.

The results may be rendered through a user interface, such as user interface 400 of FIG. 4. For example, the results area 406 may show the search results. In an example embodiment, the results area 406 is dynamically updated whenever new and/or updated results are available for a search.

Since the spatial distribution of graphical symbols in the user interface may affect the search query expression and/or corresponding search result, using asynchronous mechanisms such as XmlHttpRequest may enable automatic receiving and/or rendering of new and/or updated search results without the user selecting a submission button after a user interface operation. The user experience may thus be enhanced.

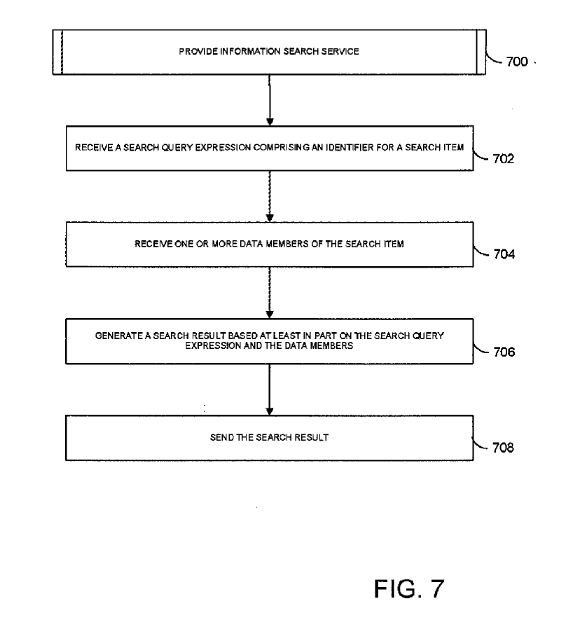

FIG. 7 is a flowchart illustrating a method for providing information according to an example embodiment of the present invention. At block 702, a search query expression is received. In an example embodiment, the search query expression is received at an information search service server, e.g., from a search service user. In an example embodiment, the search query expression comprises an identifier for one or more search items.

The search query expression may be received by any electronic device with a network interface, for example server 300 of FIG. 3 with network interface 324.

In an example embodiment, at least part of the search query expression is received in a request, such as search query expression 512 in request 510 of FIG. 5. If desired, at least part of the search query expression may also be received in an update request, for example update request 530 of FIG. 5.

According to an example embodiment, the search service server may receive an SVG document as a search query expression, as such or extended with search-specific tags. For example, the search service server may receive a search query expression comprising the LISTING 1.

At block 704, one or more data members of the search item are received, for example, at the search service server. A data member may be received by any electronic device with a network interface, for example server 300 of FIG. 3 with network interface 324.

In an example embodiment, a data member may be received in a separate request, such as request 520 of FIG. 5. Alternatively, a data member may be received in a request together with a search query expression and/or an update request, for example search query expression 512 and/or update request 530 of FIG. 5. If desired, a data member may be received in a response to a request, for example response 524 to request 522 of FIG. 5. It should be noted that a search query expression and a related data member may be received from different devices. Furthermore, each data member related to a search query expression may be received from a different device.

The search service server may receive a data member corresponding to a search item identifier in the search query expression. For example, the search query expression may be LISTING 1, the search item identifier may be “group 1-1”, and the data member may comprise a voice recording. The search service server may associate the received data member to a search item for example by an identifier received with the data member. For example, if an identifier “group 1-1” was received with a voice recording, the search service server could associate the voice recording with the search item with identifier “group 1-1”. If desired, the search service server may estimate the received data member to belong to a search item based on reception order, size, format, and/or the like. The search service server may optionally mark the received data members with the estimated identifier, as well as confirm the estimates from the user of the search service.

At block 706, a search result is generated based at least in part on the search query expression and the data members. The search result may be generated by any electronic device with processor and memory, for example server 300 of FIG. 3.

Different search results may be generated based at least in part on the capabilities of the electronic device receiving the search results, the capabilities of the server, configuration settings for the electronic device and/or the server, the communication link characteristics between the electronic device and the server, and/or the like. According to an example embodiment, a search result with high-resolution images may be generated if a broadband communication link is available between the server and the client. According to another example embodiment, a reduced size search result may be generated, for example with reduced resolution images, for example if a maximum size for a search result is exceeded. According to another example, a reduced size result may be generated, if a broadband communication link between the server and the client is too expensive or not available.

Since the search query expression and/or the data members may be based at least in part on different data formats and/or combinations of data formats, the search service server may apply heuristics to the search query expression as part of generating the search results. For example, the search query expression may be expressed as graphics image of the query area 408, and the search service server may reconstruct a textual query from the image by applying image recognition methods.

Generating the search result may comprise running a traditional text-based search of any text-format data members against a database, which would not require extensive preprocessing of the search items, but would only make use of data members already in textual format. Additionally or alternatively, generating the results may comprise using various heuristics to interpret the meaning of the data members into textual format, through for example color, shape and motion recognition or voice recognition techniques. Generating the search result may also comprise using search engines with non-textual search input and/or output, such as engines that search image content matching to an input image, for example by computing feature vectors of the input image and comparing those to the feature vectors of the image database contents.

For example, the server may generate search result from local and/or remote databases based on a search query expression, for example LISTING 1. Generating search results based on LISTING 1 may comprise, for example, running a web search with search term “coffee shop”. The search service server may replace, complement, rearrange, and/or the like the search result based on the search query expression by generating more search results based on the data members, for example the received voice recording. The search service server may call a speech-to-text service to interpret the meaning of the voice recording. If the speech-to-text service indicates the recording to include a word “chamomile” or the like, the search service server may again run a web search, for example “coffee shop chamomile”. The results from this search could indicate, for example, coffee shops that have chamomile tea in their offering. If the service would receive a GPS position as part of the search query expression, a location-aware web search could be run, for example with GPS coordinates and “coffee shop camomila” as search parameters. Based on results from this location-aware web search, the search service server could potentially return a set of coffee shops offering chamomile tea in the neighborhood of the indicated location. Further, if the search query expression indicated driving instruction be preferred, a search result with real-time navigation instructions could be provided, for example to the nearest coffee shop in the neighborhood offering chamomile tea. The search service server may also look for advertisements, for example about chamomile tea shops, to be included in the search result.

Generating the search result may comprise further processing, such as combining search results from multiple sources and/or of multiple formats into a single result document. Generating the search result may also comprise formatting the search result according to content description format. For example, the search result may comprise a completely new graphical area description including the search result description, or a partial update to the graphical area. For example, the result may comprise description of graphical elements, such as text or images and their relative and/or absolute positions.

New and/or updated results may be generated related to the same search query expression if the search service server generates more results, generates further processed results, generates results for queries with time-dependent search items, and/or the like. If desired, new and/or updated results may also be generated in response to receiving new and/or updated information about the search items and/or the data members. For example, new and/or updated results may be generated in response to added, removed, modified, and/or the like, search items and/or data members.

At block 708, the search result is sent. The search result may be sent by any electronic device with a network interface, for example server 300 of FIG. 3 with network interface 324. In an example embodiment, the search result is sent to the requestor, for example electronic device 200 of FIG. 2. It should be noted that the search result may be sent to a different device than the device from the search query expression is received.

In an example embodiment, the search service server may send the result as a response to a request, for example as a response to request 520 and/or update request 530 of FIG. 5. If desired, new and/or updated results may also be sent as they become available. The search service server may send the result in an interactive session and/or through e-mail, short message service (SMS), multimedia message service (MMS), and/or the like.

Without in any way limiting the scope, interpretation, or application of the claims appearing below, it is possible that a technical effect of one or more of the example embodiments disclosed herein may be a search service server that serves users based on their personal data and context. Another possible technical effect of one or more of the example embodiments disclosed herein may be a graphical user interface for personalized search service. Another possible technical effect of one or more of the example embodiments disclosed herein may be the formation of search user groups that share search item data and/or results between the users.

Embodiments of the present invention may be implemented in software, hardware, application logic or a combination of software, hardware and application logic. The software, application logic and/or hardware may reside on service client devices, service server devices or third party devices across networks. If desired, part of the software, application logic and/or hardware may reside on service client devices, part of the software, application logic and/or hardware may reside on service server devices, and part of the software, application logic and/or hardware may reside on third party devices across networks. The application logic, software or an instruction set is preferably maintained on any one of various conventional computer-readable media. In the context of this document, a “computer-readable medium” may be any media or means that can contain, store, communicate, propagate or transport the instructions for use by or in connection with an instruction execution system, apparatus, or device.

If desired, the different functions discussed herein may be performed in any order and/or concurrently with each other. Furthermore, if desired, one or more of the above-described functions may be optional or may be combined.

Although various aspects of the invention are set out in the independent claims, other aspects of the invention comprise any combination of features from the described embodiments and/or the dependent claims with the features of the independent claims, and not solely the combinations explicitly set out in the claims.

It is also noted herein that while the above describes exemplifying embodiments of the invention, these descriptions should not be viewed in a limiting sense. Rather, there are several variations and modifications which may be made without departing from the scope of the present invention as defined in the appended claims.

1.-24. (canceled)

25. A method, comprising:
receiving a request comprising a search query expression, the search query expression comprising an identifier for a search item;
receiving a data member of the search item;
generating a search result based at least in part on the search query expression and the data member; and
sending the search result.

26. A method according to claim 25, wherein:
receiving the data member of the search item comprises:
receiving the identifier for the search item with the data member of the search item.

27. A method according to claim 25, wherein:
receiving the data member of the search item comprises:
sending a request comprising the identifier for the search item; and
receiving a response comprising the data member of the search item.

28. A method according to claim 25, comprising:
before receiving the request comprising the search query expression, sending a document comprising a description of a graphical area.

29. A method according to claim 25, further comprising:
receiving an update request comprising the data member and the identifier for the search item; and
sending a response comprising an update to the search result.

30. A method according to claim 25, wherein:
the identifier for the search item comprises at least one of:
a value defined in the request, a value derived from the search item, a value tied to a session determined by the request, an internationalized resource identifier, an universal resource identifier, a universal resource locator, a universal resource name, a universally unique identifier, a digital object identifier, an international standard book number and a member of a unique namespace.

31. A method according to claim 25, wherein:
the data member comprises at least one of:
a text document, an image, a photo, a video, a voice recording, a multimedia document, a script, an executable software application, a graphical user interface control, a universal resource identifier, a parameter for inclusion of the search item in the search query, a parameter for relevance of the search item for the search query, a parameter for group membership of the search item, a numeric property, a textual property, a boolean property and a binary property.

32. A method, comprising:
generating a graphical area for representation of a search query and a search result;
associating, in response to user input, a search item to a search query;
generating a search query expression comprising an identifier for the search item;
sending a request comprising the search query expression;
sending a data member; and
receiving a search result.

33. A method according to claim 32, wherein:
the graphical area comprises a query area;
the search query is associated with the query area;
the search item is associated with a graphical symbol; and
associating the search item to the search query comprises placing the graphical symbol on the query area.

34. A method according to claim 33, wherein
generating the graphical area comprises:
retrieving a document comprising a description for the graphical area; and
rendering the graphical area based at least in part on the document;
the user input comprises a move operation of the graphical symbol to a position on the query area; and
associating the search item to the search query further comprises setting a data member of the search item to correspond to the position.

35. A method according to claim 32, further comprising:
rendering the search result;
sending a search query update request comprising the data member;
receiving a response to the search query update request comprising an update to the search result; and
rendering the update to the search result.

36. A method according to claim 32, wherein
the data member comprises at least one of:
a text document, an image, a photo, a video, a voice recording, a multimedia document, a script, an executable software application, a graphical user interface control, a universal resource identifier, a parameter for inclusion of the search item in the search query, a parameter for relevance of the search item for the search query, a parameter for group membership of the search item, a numeric property, a textual property, a boolean property and a binary property.

37. A method according to claim 32, wherein:
the identifier comprises at least one of:
a value defined in the request, a value derived from the search item, a value tied to a session determined by the request, an internationalized resource identifier, an universal resource identifier, a universal resource locator, a universal resource name, a universally unique identifier, a digital object identifier, an international standard book number and a member of a unique namespace.

38. An apparatus, comprising:
a network interface;
a processor coupled to the network interface; and
memory coupled to the processor and having instructions that cause the apparatus to:
receive, through the network interface, a request comprising a search query expression, the search query expression comprising an identifier for a search item;
receive, through the network interface, a data member;
generate a search result based at least in part on the search query expression and the data member; and
send the search result through the network interface.

39. An apparatus, comprising:
a user input interface;
a network interface;
a processor coupled to the user input interface and the network interface; and
memory coupled to the processor and having instructions that cause the apparatus to:
generate a graphical area for representation of a search query and a search result;
associate, in response to a user input through the user input interface, a search item to a search query;
generate a search query expression comprising an identifier for the search item;
send, through the network interface,
a request comprising the search query expression and
a data member; and
receive, through the network interface, a search result based at least in part on the search query expression and the data member.

40. An apparatus according to claim 39, wherein:
the graphical area comprises a query area;
the search query is associated with the query area;
the search item is associated with a graphical symbol; and
the association of the search item to the search query comprises placement of the graphical symbol on the query area.

41. An apparatus according to claim 40, wherein:
The generation of the graphical area comprises:
retrieval, through the network interface, of a description document for the graphical area, and generation of the graphical area based at least in part on the description document;
the user input comprises a move operation of the graphical symbol to a position on the query area; and
association of the search item to the search query further comprises setting a second data member to correspond the position.

42. An apparatus according to claim 39, further comprising:
sending, through the network interface, an update request;
receiving, through the network interface, a response to the update request comprising an update to the search result; and
generating a results area with the update.

43. An apparatus according to claim 39, wherein:
the data member comprises at least one of a text document, an image, a photo, a video, a voice recording, a multimedia document, a script, an executable software application, a graphical user interface control, a universal resource identifier, a position, a parameter for inclusion of the search item in the search query, a parameter for relevance of the search item for the search query, a parameter for group membership of the search item, a numeric property, a textual property, a Boolean property and a binary property.

44. A computer-readable medium encoded with instructions that, when executed by a computer, cause the computer to perform:
generating a graphical area for representation of a search query and a search result;
associating, in response to user input, a search item to the search query;
generating a search query expression comprising an identifier for the search item;
sending a request comprising the search query expression;
sending a data member; and
receiving the search result.
